(19) United States
(12) Patent Application Publication
(10) Pub. No.: US 2024/0149431 A1
(43) Pub. Date: May 9, 2024

(54) COOPERATIVE MOVABLE ROBOT IN THE FORM OF A COLUMN

(71) Applicant: MECABOTIX, TOULOUSE (FR)

(72) Inventors: Jean-Christophe FAUROUX, QUINT-FONSEGRIVES (FR); Zine Elabidine CHEBAB, BOUMERDES (DZ)

(73) Assignee: MECABOTIX, TOULOUSE (FR)

(21) Appl. No.: 18/277,997

(22) PCT Filed: Feb. 18, 2022
(86) PCT No.: PCT/EP2022/054160

§ 371 Date: Aug. 20, 2023

(30) Foreign Application Priority Data
Feb. 19, 2021 (FR) FR2101651

(51) Int. Cl. B25J 5/00; B25J 9/00; B66F 9/08

(52) U.S. Cl. CPC B25J 5/007; B25J 9/0084; B66F 9/087

(57) ABSTRACT

The invention relates to a cooperative mobile robot, characterized in that it comprises a slim structure (12) in the form of a column in a main longitudinal direction (13) which is oriented substantially upwards when the robot is in the operating position, at least one locomotion means (14) which is arranged at a lower end of said slim structure (12) and is configured to provide at least a first point of contact with the ground when the robot is in the operating position, at least one stabilization means (20) which is connected to the slim structure (12) and is configured to provide at least a second point of contact with the ground when the robot is in the operating position, and at least one attachment means (16) which is configured to receive at least one means of structural connection with another cooperative mobile robot.

### TECHNICAL FIELD OF THE INVENTION

The invention relates to a cooperative mobile robot which can be associated with one or more other cooperative mobile robots. In particular, the invention relates to a mobile robot which can be used in different sectors, for example handling, transport and load handling for extremely varied masses, sizes and shapes, in a variety of environments.

### TECHNOLOGICAL BACKGROUND

Cooperative mobile robots are used for transporting loads in the logistics sector. In particular, some robots are configured for movement in a logistics warehouse so as to collect and transport loads from one point to another in the warehouse. When the load is too heavy, several robots can cooperate in order to transport said load.

The following notations specific to cooperative robots capable of working in a group are used:
Mono-robot or m-bot: single robotic entity capable of performing a task autonomously, for example transporting a light load which is not too bulky.
Poly-robot or p-bot: robotic entity formed of a group of p mono-robots to perform a task. In the case of load transporting, the load is part of the poly-robot.

Several designs of mono-robots and their grouping into poly-robots have been proposed in the prior art, in particular for the collaborative lifting of loads.

However, these poly-robots have some disadvantages. In particular, the poly-robots cannot turn on the spot or move laterally which limits the uses thereof and the possibilities therefor in a logistics warehouse. Finally, the cooperative aspect is fully obtained by the synchronization of mono-robot commands, without there being a physical connection between these mono-robots other than the transported load.

The inventors have sought a solution to overcome these disadvantages and improve the current cooperative mobile robots.

### AIMS OF THE INVENTION

The invention aims to provide a cooperative mobile robot adapted for handing and transporting loads, in particular in a logistics warehouse.

The invention also aims to provide, in at least one embodiment, a cooperative mobile robot which is able to form, with other robots of the same type, combinations which can respond to different needs.

The invention aims in particular to provide, in at least one embodiment, a compact cooperative mobile robot having a small footprint and being able to use aisles for human operators in a logistics warehouse, having a width of about 1 m.

The invention also aims to provide, in at least one embodiment of the invention, a cooperative mobile robot having a good lifting capacity, being able to lift heavy loads over a long distance.

The invention also aims to provide, in at least one embodiment of the invention, a cooperative mobile robot having good mobility, in particular in terms of steering, with a capacity to move omnidirectionally and to overcome obstacles.

The invention also aims to provide, in at least one embodiment, a group of cooperative mobile robots connected together and making it possible to be adapted to different types of load to be carried and of working environment.

### DESCRIPTION OF THE INVENTION

To this end, the invention relates to a cooperative mobile robot, characterized in that it comprises a slim structure in the form of a column in a main longitudinal direction which is oriented substantially upwards when the robot is in the operating position, at least one locomotion means which is arranged at a lower end of said slim structure and is configured to provide at least a first point of contact with the ground when the robot is in the operating position, at least one stabilization means which is connected to the slim structure and is configured to provide at least a second point of contact with the ground when the robot is in the operating position, and at least one attachment means which is configured to receive at least one means of structural connection with another cooperative mobile robot.

Owing to its column shape, a mobile robot in accordance with the invention is extremely compact, has a small footprint and in particular can edge along narrow aisles in a logistics warehouse, for example aisles provided for the size of a human operator, without it being necessary to enlarge the aisle. Its small footprint also makes it possible to be able to deploy such a robot in other contexts where accessibility is poor for robots which are too bulky. Its compactness also makes it possible to reduce the ground surface necessary for storing unused cooperative mobile robots.

The column structure also makes it possible to group together masses above the contact between the robot and the ground. The slim shape lends itself to the integration of a lifting means (or lifting mast) with a long movement distance and a degree of freedom provided with a high loading capacity, whilst limiting the size on the ground. The column shape is characterized by a length substantially greater than the width and the depth of the structure, in particular a length at least three times greater than the width of the structure and at least three times greater than the depth of the structure. The width and the depth can advantageously have substantially identical dimensions, thereby forming a square base, or even different dimensions, thereby forming a rectangular base. Preferably, the footprint of the cooperative mobile robot is close to that of a human operator: the cooperative mobile robot can thus travel in particular in the aisles or pass through doors for human operators, which a robot would not normally be able to do because they would be too narrow. In particular, the robot can travel in aisles or through doors with widths of the order of 1 m. The operating position is the position in which the robot can move, with the locomotion and stabilization means forming the supports on the ground, and in which the slim structure is generally vertical, i.e. oriented substantially upwards and with the slim structure having a small footprint.

The stabilization means make(s) it possible to improve the stability of the cooperative mobile robot and preferably make(s) it possible for the cooperative mobile robot to move alone without it being necessary to be connected to other cooperative mobile robots. According to at least one variant of the invention, several cooperative mobile robots can thereby move independently in order to be grouped together and connected together to form a group of cooperative mobile robots, or poly-robot. When a cooperative mobile robot is included in a poly-robot comprising at least three cooperative mobile robots, the stabilization means can be folded away if the poly-robot has a sufficient number of points of support on the ground.

The connection means, also called cooperation means, permit a mechanical connection between the cooperative mobile robots. The attachment means or anchoring means make(s) it possible to receive these connection means which may be of different types, with manual or automated setting. In particular, the attachment means can, according to the variants of the invention, make it possible to receive a connection means by a nesting structure or other attachment means, for example a ball joint, a pivot, etc. The attachment means can be holes which may or may not be threaded, protruding pieces which may or may not be threaded, associated with studs, rivets, screws, pins, etc. depending upon the desired assembly processes.

As described above, a single cooperative mobile robot can be called a mono-robot or m-bot. When several robots are grouped by said connection, they are referred to as a poly-robot or p-bot. Several particular forms of poly-robot comprising p cooperative mobile robots can be mentioned:
Bi-robot or bi-bot: poly-robot with p=2.
Tri-robot or tri-bot: poly-robot with p=3.
Quadri-robot or quadri-bot: poly-robot with p=4.
Octo-robot or octo-bot: poly-robot with p=8.
Dodeca-robot or dodeca-bot: poly-robot with p=12.

Advantageously and in accordance with the invention, the cooperative mobile robot comprises at least one vertical lifting means, configured to allow raising of a load in an axis substantially parallel to the main longitudinal direction.

According to this aspect of the invention, the lifting means makes it possible, for example, to grasp a load from beneath, for example grasping a pallet or bundle accessible from beneath. If the vertical lifting means is not able to grasp a load by itself because the load is too heavy, too bulky or risks making the cooperative mobile robot unbalanced, the combination of several lifting means of each cooperative mobile robot of a poly-robot may allow lifting of said load.

According to one variant of the invention, the vertical lifting means is connected to the slim structure by a slide linkage extending substantially in parallel with the main longitudinal direction. The slide linkage therefore allows vertical movement when the cooperative mobile robot is in the operating position.

Advantageously and in accordance with the invention, the slim structure comprises a guide rail extending in a direction substantially in parallel with the main longitudinal direction, said guide rail being configured to receive at least one vertical lifting means. The guide rail thereby forms the slide linkage.

Advantageously and in accordance with the invention, the locomotion means are formed by a wheel and means for steering the wheel about an axis which substantially coincides with the main longitudinal direction of the slim structure.

According to this aspect of the invention, the wheel can be steered about its steering axis and can effect an unlimited number of rotations, in particular owing to a slip ring for the electric power supply. The steering means are, for example, a steerable turret controlled by the cooperative mobile robot.

A poly-robot provided with such cooperative mobile robots can in particular steer about any point on the ground by coordination of the steering of each cooperative mobile robot, including about a point beneath the poly-robot, which corresponds to steering on the spot.

Advantageously and in accordance with another variant of the invention, the locomotion means comprise several wheels connected by one or more axles. The wheels can also be replaced with tracks.

Advantageously and in accordance with the invention, the cooperative mobile robot comprises at least one handling arm.

According to this aspect of the invention, the handling arm makes it possible to handle small loads, e.g. to unpack transported products, form batches of assorted components (packages or kits) or ensure shelf filling. The handling arm can be fixed at multiple locations on the slim structure or the mobile part of the lifting means as close as possible to the load to be transported.

Advantageously and in accordance with the invention, the cooperative mobile robot comprises means for measuring a force applied by a load and transmitted to the ground via the points of contact with the ground, when the robot is in the operating position.

According to this aspect of the invention, the force measurement makes it possible to characterize the load carried by the cooperative mobile robot, the distribution thereof on the supports on the ground, and thus to adapt the behavior of the cooperative mobile robot or the group of cooperative mobile robots to which the cooperative mobile robot belongs. The information representing the force applied by the load, also called stability margin, makes it possible for example to adjust the control of the lifting means, of the stabilization means, of the locomotion means, etc.

Advantageously and in accordance with the invention, the cooperative mobile robot comprises a stability management device, configured to adjust the position of each stabilization means based on at least said measured force.

According to this aspect of the invention, the stability management device makes it possible to adjust the position of each stabilization means based on the transported load, the position of the robot (inclination of the slim structure, height of the lifting means), the dynamic behavior of the robot (speed, acceleration), etc.

Advantageously and in accordance with the invention, a stabilization means comprises a load-bearing box and a wheel arranged at a first end of the box and forming the second point of contact with the ground, said box being fixed to the slim structure by a pivot linkage at a second end of the arm.

Advantageously and in accordance with another variant of the invention, the linkage has kinematics other than a pivot linkage, e.g. a multi-bar mechanism.

Advantageously and in accordance with the invention, at least one stabilization means comprises at least one battery for supplying power to the cooperative mobile robot.

According to this aspect of the invention, the presence of at least one power supply battery in the stabilization means makes it possible to add mass as a counterweight with respect to the load and to thereby stabilize the cooperative mobile robot. The fact that this mass is close to the ground also improves the terrain handling on uneven ground.

The invention also relates to a group of cooperative mobile robots in accordance with the invention, connected together by the connection means. This group forms a poly-robot as described above.

A poly-robot can have several different structures, with a different number of robots. The connection means make it possible to mechanically associate the robots with each other and can be of different forms, for example plates, beams or more complex mechanical assemblies, or even motorized ones to allow the connection to be automated.

Advantageously and in accordance with the invention, the robot group comprises two cooperative mobile robots each comprising lifting means formed of a single fork and comprising at least one stabilization means.

Advantageously and in accordance with one variant of the invention, the group of cooperative mobile robots comprises two cooperative mobile robots each comprising at least one wheel, at least two different cooperative mobile robot wheels being arranged such that the axes of rotation of which coincide during zero steering.

Such a bi-robot therefore comprises an axle-like system forming a gryopod, the wheels of which share the same axis when the bi-robot moves in a straight line.

Advantageously and in accordance with another variant of the invention, the group of cooperative mobile robots comprises two cooperative mobile robots each comprising at least one wheel characterized by a main plane perpendicular to the axis of rotation, at least two different cooperative mobile robot wheels being arranged such that the main planes of which are coplanar during zero steering.

Such a bi-robot therefore comprises a “bicycle”-like system, i.e. with wheels extending in the same plane when the bi-robot moves in a straight line. This configuration may require lateral stabilization, for example provided by the respective stabilization means of each cooperative mobile robot.

A poly-robot can comprise more than two mono-robots, as an even or odd number, with different configurations. The poly-robots can also form a long convoy for use with very long objects, for example a long pipe, by using several groups of cooperative mobile robots.

When several robots form a poly-robot, degrees of mobility are taken into account in the connection chains so as to be able to retain constant and propulsive supports on the ground and to ensure continuous supporting of the loads. The poly-robot can be controlled by a central, external control center or selected from one of the control devices of a cooperative mobile robot of the group of robots.

The implementation of poly-robots by using a plurality of mobile robots in accordance with the invention makes it possible to facilitate maintenance, which can be performed on each cooperative mobile robot independently from the other cooperative mobile robots. It is also possible to replace a faulty cooperative mobile robot with another, working, cooperative mobile robot so as not to interrupt the use of the poly-robot whilst the faulty cooperative mobile robot is being repaired. Advantageously and in accordance with one variant of the invention, the connection means can, for example, comprise a structural piece nested at each of its ends in a piece of a cooperative mobile robot, the cooperative mobile robots thereby being nested. Advantageously and in accordance with another variant of the invention, the connection means can comprise a lockable kinematic chain permitting a degree of mobility between the cooperative mobile robots, for example during loading or to be adapted to uneven ground.

Advantageously and in accordance with the invention, the connection means can each allow their dimensions to be manually or automatically set.

More generally, the connection means can be formed of a robust locking system of the desired form, sized according to the forces involved, and with a minimum number of linkages to improve the rigidity and facilitate management of the degrees of mobility between cooperative mobile robots, and so as to avoid hypostaticity or hyperstaticity situations of the poly-robot placed on the ground.

Advantageously and in accordance with one variant of the invention, the connection means are motorized for an automatic connection.

Advantageously and in accordance with one variant of the invention, the connection means are non-motorized and are configured to be installed manually by an operator.

Advantageously and in accordance with the invention, the connection means can be used as support means for the stabilization when the group of cooperative mobile robots is stationary or during the locomotion thereof.

Advantageously and in accordance with the invention, at least one connection means is connected to lifting means of at least two cooperative mobile robots.

Advantageously and in accordance with the invention, the group of robots comprises means for overcoming obstacles, comprising:
means for elevating at least one locomotion means by a lifting means of a cooperative mobile robot,
means for maintaining the stability margin by controlling the elevating means and said locomotion means from information representing internal forces gathered by the force-measuring means of one or more cooperative mobile robots.

The means for overcoming obstacles make it possible to increase the mobility of the group of cooperative mobile robots by making it possible to overcome small obstacles owing to a vertical degree of mobility of at least one of the cooperative mobile robots and management of the stability of the group.

Advantageously and in accordance with the invention, the group of robots comprises at least three cooperative mobile robots, and at least one connection means forming a lateral pallet stacking device, configured to be connected to each cooperative mobile robot.

According to this aspect of the invention, the lateral stacking device makes it possible to transport a pallet and place it on or remove it from a shelf rack arranged on the side of the path of the group of robots.

Advantageously and in accordance with the invention, the connection means comprise at least one mechanical and/or electrical and/or hydraulic transmission means.

According to this aspect of the invention, the connection means thus make it possible to transmit power and/or mechanical and/or electrical and/or hydraulic information from one cooperative mobile robot of the group to another cooperative mobile robot of the group.

The invention also relates to a mobile robot and a group of mobile robots which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic side view of a mobile robot in accordance with a first embodiment of the invention;

FIG. 2 is a schematic perspective view of a mobile robot in accordance with a second embodiment of the invention;

FIG. 3 is a schematic perspective view of a mobile robot in accordance with a third embodiment of the invention;

FIG. 4 is a schematic perspective view of a mobile robot in accordance with a fourth embodiment of the invention;

FIG. 5 is a schematic perspective view of a mobile robot in accordance with a fifth embodiment of the invention;

FIG. 6 is a schematic perspective view of a poly-robot in accordance with a first embodiment of the invention;

FIG. 7 is a schematic top view of a poly-robot in accordance with the first embodiment of the invention;

FIG. 8 is a schematic perspective view of a poly-robot in accordance with a second embodiment of the invention;

FIG. 9 is a schematic top view of a poly-robot in accordance with the second embodiment of the invention;

FIG. 10 is a schematic perspective view of a poly-robot in accordance with a third embodiment of the invention;

FIG. 11 is a schematic perspective view of a poly-robot in accordance with a fourth embodiment of the invention;

FIG. 12 is a schematic front view of a poly-robot in accordance with the fourth embodiment of the invention;

FIG. 13 is a schematic perspective view of a poly-robot in accordance with a fifth embodiment of the invention;

FIG. 14 is a schematic perspective view of a poly-robot in accordance with a sixth embodiment of the invention;

FIG. 15 is a schematic perspective view of a poly-robot in accordance with a seventh embodiment of the invention;

FIG. 16 is a schematic perspective view of a poly-robot group in accordance with an eighth embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

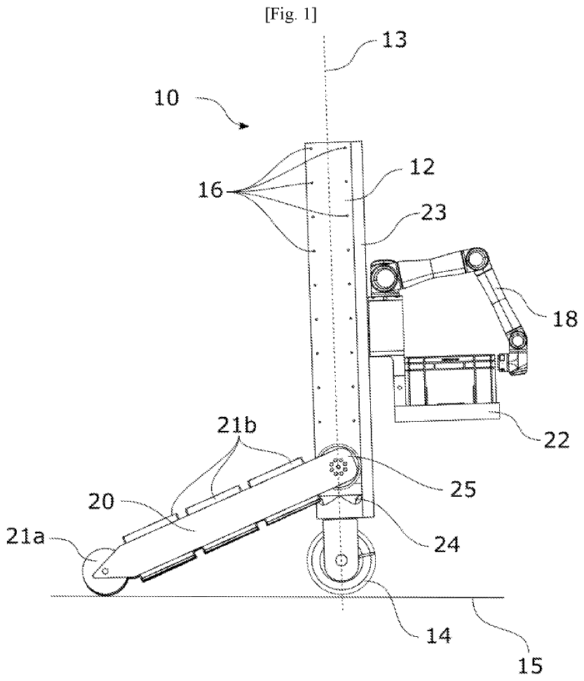

FIG. 1 is a schematic side view of a cooperative mobile robot in accordance with a first embodiment of the invention, also called mono-robot.

The cooperative mobile robot 10 is formed of a slim structure 12 in the form of a column in a main longitudinal direction 13 oriented substantially upwards or vertically when the robot is in the operating position. The cooperative mobile robot comprises at least one locomotion means (in this case a wheel 14 mounted on a steerable turret) at the lower part, at the lower end of the slim structure 12. The locomotion means makes it possible in particular to provide at least a first point of contact with the ground 15 when the robot is in the operating position.

The mobile robot 10 comprises at least one, preferably several, attachment means 16 allowing connection to another mobile robot 10. These attachment means 16 are of variable shape and size to allow the reception of different types of structural connection means making it possible to connect the cooperative mobile robot 10 to one or more other cooperative mobile robots to form a poly-robot, as described hereinafter. The attachment means 16 shown in the figures are one example and other types of attachment means can be proposed, having different sizes and locations.

The mobile robot further comprises a handling arm 18, stabilization means and lifting means 22.

The stabilization means 20 can, in some embodiments, form connection means. The stabilization means 20 are in this case formed of a rigid and rectangular box, making it possible to create at least a second point of contact with the ground, and preferably comprise a passive wheel 21a at a first end to facilitate the movement of the cooperative mobile robot 10. The stabilization means 20 can also carry the removable batteries 21b, in this case three removable batteries making it possible to supply the cooperative mobile robot 10 with power, also making it possible to improve the stability of the cooperative mobile robot by adding a mass serving as a counterweight for the load and close to the supports on the ground. In other embodiments, not shown, the batteries are integrated into the stabilization means and cannot be seen from the outside. The stabilization means 20 are in this case fixed to the slim structure 12 by pivot-type fasteners 25 at a second end so as to allow at least one of the stabilization means to be folded back along the slim structure, for example when the cooperative mobile robot is in the stored position, or when the cooperative mobile robot forms part of a group of cooperative mobile robots as described hereinafter in the description. The pivot linkage 25 can be motorized, which allows the position of the stabilization means 20, in particular the position of the stabilization contacts with the ground, to be controlled. This control allows the stabilization of the mobile robot to be managed based on the carried load and the transport height.

The lifting means 22 are in this case formed of a tray allowing the transportation of crates which can be taken or removed by the handling arm 18. The lifting means are mounted on a guide rail 23 arranged in a direction in parallel with the longitudinal direction of the slim structure 12 over the entire length thereof and allowing elevation movement. The use of full extension slides or several consecutive slides makes it possible to increase the movement distance.

The cooperative mobile robot 10 also comprises a force sensor 24 making it possible to measure the force applied thereto, in particular to measure the force applied by a load and transmitted to the ground by the drive wheel 14 when the robot is in the operating position. Other sensors can be integrated into the wheels of the stabilizers 21a or of the pivot linkage 25. This measurement makes it possible in particular to measure the mass of the transported load and to balance the single robot as a mono-robot or in the poly-robot formation. This measurement is transmitted to a stability management device which can act on the motorization of the pivot linkage of the stabilization means. In particular, the sensor can make it possible to detect the risks of tilting by calculating a margin of stability of the mono-robot or poly-robot, to prevent lifting if the supports are not stable, and to determine the center of gravity of the load lifted by the poly-robot.

The mobile robot can also include elements, visible or hidden, such as:
sensors, for example:
   load size sensor,
   environment anti-collision sensor,
   anti-crush sensor beneath the lifting means,
   aisle lateral positioning sensor,
   sensor for detecting objects going past shelf racks,
wheel locomotion and steering motorization;
stabilization means inclination motorization;
lifting means motorization;
a control system;
a user interface, for example a touch screen;
an emergency stop means;
attachment points for connection means or a handling arm.

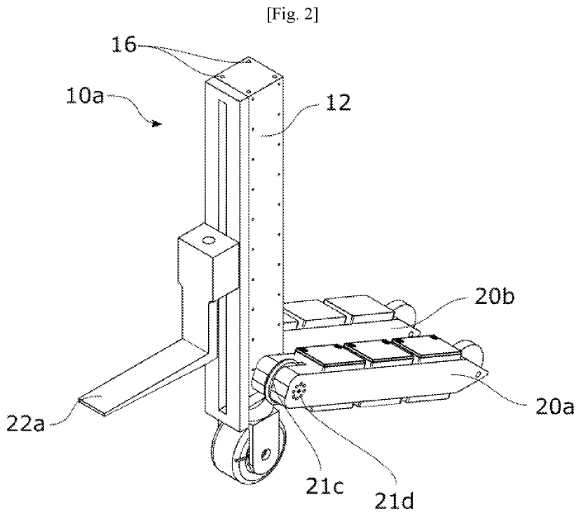

FIGS. 2 to 5 are schematic perspective views of different embodiments of a cooperative mobile robot 10.

According to a second embodiment shown in FIG. 2, the cooperative mobile robot comprises a single fork 22a and two stabilization means, a first stabilization means 20a and a second stabilization means 20b which are connected to the slim structure 12 on two lateral parts of the slim structure and make it possible to form three non-aligned supports on the ground, which makes it possible for the mono-robot to have good stability. Each stabilization means 20a, 20b in this case comprises three batteries.

A wheel 21c can be added at the second end of one or each stabilization means 20a, 20b to allow the movement of the stabilization means when it is not connected to the slim structure.

The stabilization means 20 can also comprise linking means 21d making it possible to attach another cooperative mobile robot or another stabilization means.

As shown in this figure, attachment means 16 can be present on the upper base of the cooperative mobile robot. This feature can be applied to all the embodiments described in this application, even if these attachment means cannot be seen, in particular in FIG. 1.

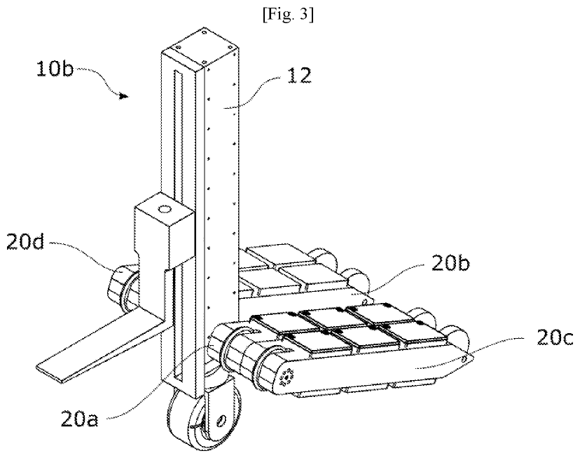

The cooperative mobile robot 10b in accordance with the third embodiment of FIG. 3 can be obtained by adding stabilization means via these linking means on each side of the cooperative mobile robot, the cooperative mobile robot 10b therefore comprising four stabilization means 20a, 20b, 20c, 20d, two on each side of the slim structure 12 for improved stability. The presence of these four stabilization means allows improved distribution of the weight and improved stabilization on the ground, which makes it possible in particular to carry heavier loads and/or to carry loads at increased heights by reducing the risks of instability.

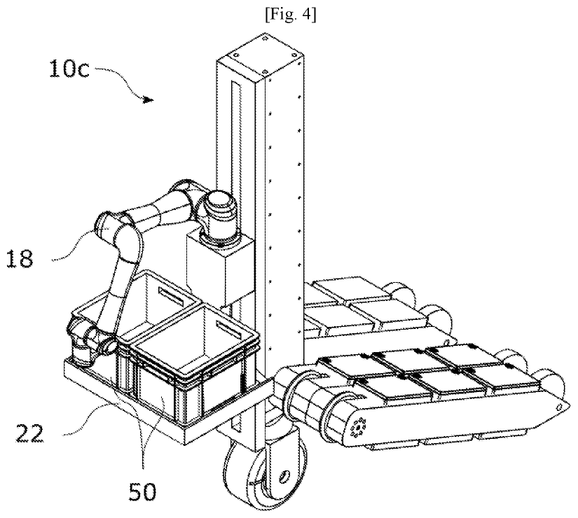

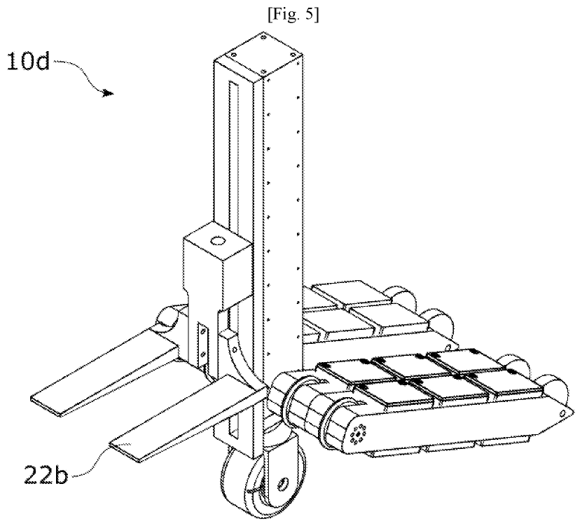

The cooperative mobile robot 10c in accordance with the fourth embodiment of FIG. 4 and the cooperative mobile robot 10d in accordance with the fifth embodiment of FIG. 5 are equivalent to this third embodiment in which the lifting means are formed respectively by a tray 22 associated with a handling arm 18 as in the first embodiment, or a double fork 22b. The tray 22 makes it possible for example to transport two crates 50 which are handled by the handling arm, and the double fork 22b makes it possible to transport standardized pallets. The loads are transported in a cantilevered manner.

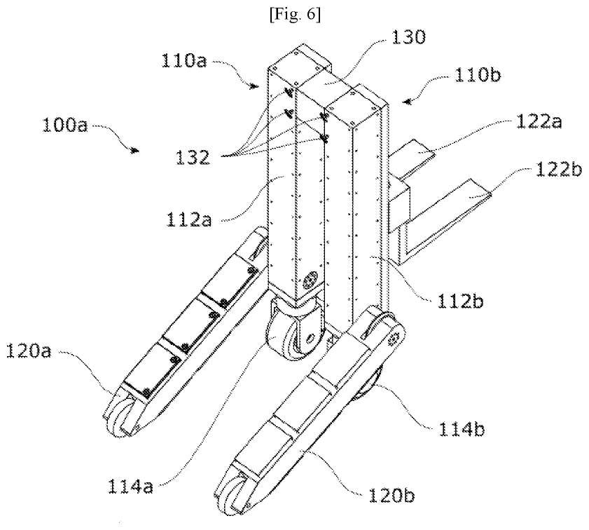

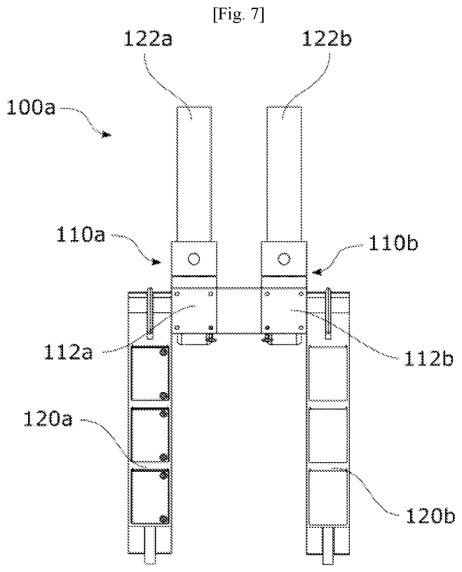

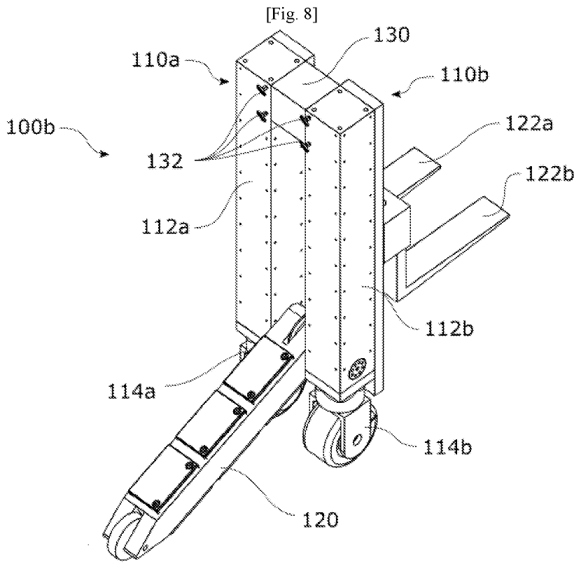

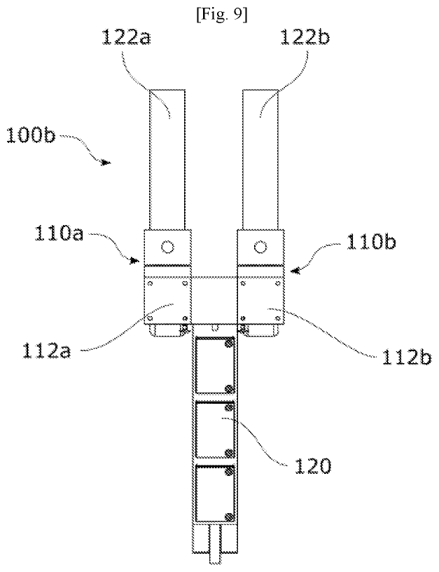

FIG. 6 and FIG. 7 show schematic perspective and top views of a group of cooperative mobile robots or poly-robot 100a of the bi-robot type in accordance with a first embodiment of the invention. FIGS. 8 and 9 show schematic perspective and top views of a poly-robot 100b of the bi-robot type in accordance with a second embodiment of the invention.

The poly-robots 100a and 100b or bi-robot are formed of two cooperative mobile robots, or mono-robots, a first cooperative mobile robot 110a and a second cooperative mobile robot 110b, as described above, connected together by cooperation means, in this case a fixed cross-bar 130 nested on the slim structure of each mobile robot and fixed by fixing means 132.

The first mobile robot 110a comprises in particular a slim structure 112a, a wheel 114a and lifting means 122a.

The second mobile robot 110b comprises in particular a slim structure 112b, a wheel 114b and lifting means 122b.

Each lifting means is a single fork, the combination of the two single forks making it possible to lift standardized pallets. The loads are carried in a cantilevered manner on the forks.

The cross-bar 130 is connected respectively to an attachment means of the first mobile robot 110a and to an attachment means of the second mobile robot 110b, the attachment means being located in the slim structure of each mobile robot.

According to other embodiments, the cross-bar is connected to two attachment means arranged in the lifting means.

According to the first embodiment of FIGS. 6 and 7, the poly-robot 100a comprises two stabilization means 120a and 120b, a first stabilization means 120a attached only to the first cooperative mobile robot 110a, and a second stabilization means 120b attached only to the second cooperative robot 110b. This configuration makes it possible to improve the stability of the poly-robot which has four points of contact with the ground.

According to the second embodiment of FIGS. 8 and 9, the poly-robot 100b comprises a stabilization means 120 attached to the two cooperative mobile robots 110a, 110b between said robots. This configuration makes it possible to reduce the overall size of the poly-robot.

The stabilization means are similar to those described with reference to FIGS. 1 to 5.

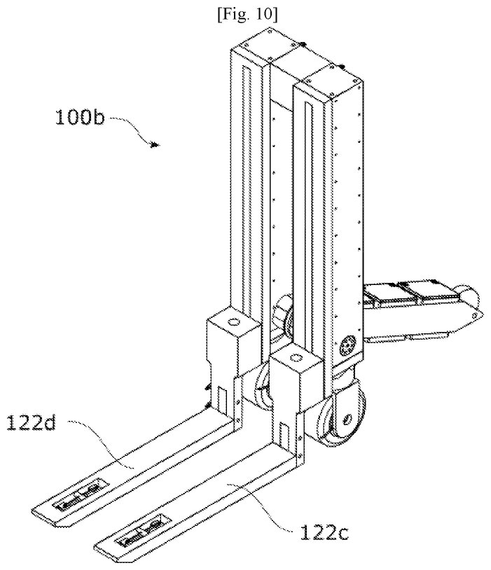

FIG. 10 is a schematic perspective view of a poly-robot 100c in accordance with a third embodiment of the invention, similar to the second embodiment in which the lifting means 122c, 122d are of the pallet truck-type.

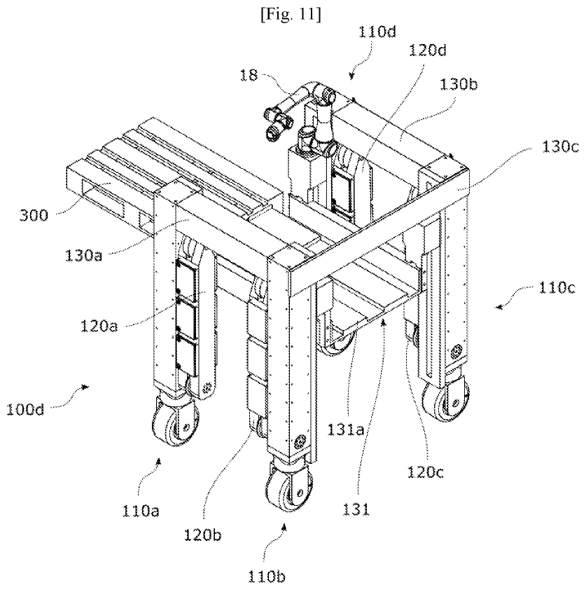

FIGS. 11 to 14 schematically show different modes of poly-robots configured for the lateral stacking of pallets 300. The poly-robots comprise three or four cooperative mobile robots and carry the load between the cooperative mobile robots at least during movement and are thus stable. The loads are carried in a cantilevered manner only during stacking of pallets.

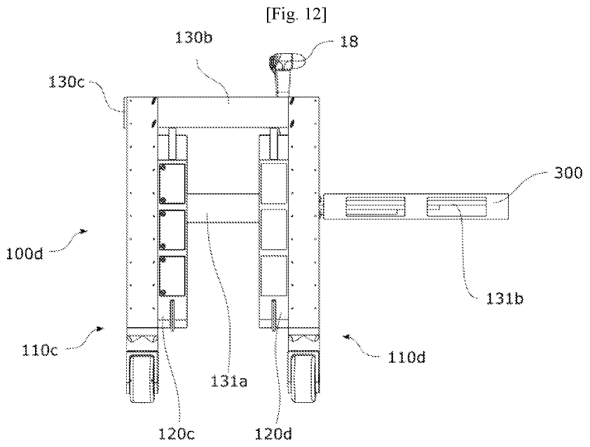

FIGS. 11 and 12 are schematic perspective and front views of a poly-robot 100d in accordance with a fourth embodiment of the invention comprising four cooperative mobile robots 110a, 110b, 110c, 110d as described above, thereby forming a quadri-robot. Alternatively, it can be considered that the poly-robot 110d is formed of two bi-robots each formed of two cooperative mobile robots, the two bi-robots facing each other such that the lifting means of the cooperative mobile robots of one bi-robot face the lifting means of the cooperative mobile robots of the other bi-robot.

Since the four cooperative mobile robots 110a, 110b, 110c, 110d form four points of contact with the ground, the respective stabilization means 120a, 120b, 120c, 120d thereof are folded away along each slim structure. Folding can be performed manually or by a motor arranged in the slim structure or in the stabilization means acting on the pivot linkage described above. The stabilization means can be unfolded to once again form a point of support on the ground if one cooperative mobile robot is detached or in some situations for example in order to increase the stability during load stacking.

The poly-robot 100d comprises connection means 130a, 130b, 130c, 131 making it possible to mechanically link the cooperative mobile robots together: the cross-bars 130a and 130b in the form of beams connect, on the one hand, the cooperative mobile robot 110a to the cooperative mobile robot 110b and the cooperative mobile robot 110b to the cooperative mobile robot 110c. A plate 130c connects the cooperative mobile robot 110b to the cooperative mobile robot 110c. Given that the robot travels in the aisles in a forward direction substantially in parallel with said plate 130c, the plate 130c makes it possible to reduce the lateral size of the poly-robot 100d.

Another connection means is formed by a lateral stacking device 131, connected to each cooperative mobile robot 110b by the respective lifting means thereof, thereby making it possible to modify the height of the lateral stacking device 131 by simultaneously controlling all of the lifting means. The lateral stacking device 131 comprises in particular a central tray 131a configured to remain arranged between the cooperative mobile robots and a sliding device 131b allowing placement beneath a pallet in a shelf rack, lifting of this pallet and movement of the pallet above the central tray by folding away the sliding device, as well as unfolding the sliding device to take away the pallet above a shelf rack, placement of the pallet in the shelf rack and folding away in the lateral stacking device once the pallet is placed.

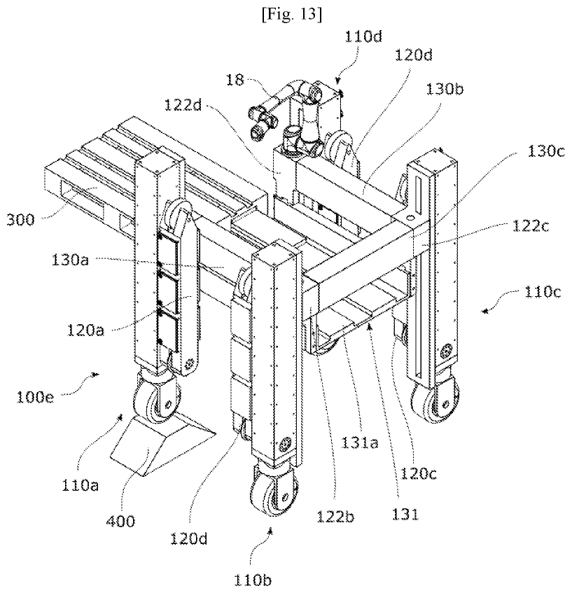

FIG. 13 is a schematic perspective view of a poly-robot 100e in accordance with a fifth embodiment of the invention. In this embodiment similar to the fourth embodiment, the connection means are attached to the lifting means of each cooperative mobile robot: a first cross-bar 130a is connected to the lifting means of the first cooperative mobile robot 110a (not shown) and to the lifting means 122b of the second cooperative mobile robot 110b, a second cross-bar 130b is connected to the lifting means 122c of the third cooperative mobile robot 110c and to the lifting means 122d of the fourth cooperative mobile robot 110d, and a third cross-bar 130c is connected to the lifting means 122b of the second cooperative mobile robot 110b and to the lifting means 122c of the third cooperative mobile robot 110c.

This arrangement permits controlled elevation of each cooperative mobile robot by the action of the lifting means, for example in this case the lifting of the first cooperative mobile robot 110a to overcome an obstacle 400. This arrangement of the connection means can be used in other configurations, for example in bi-robots as described above by moving the cross-bar to the level of the lifting means.

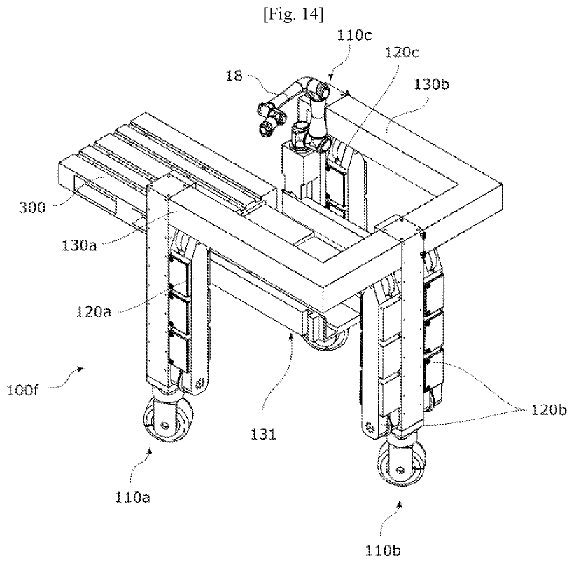

FIG. 14 is a schematic perspective view of a poly-robot 100f in accordance with a sixth embodiment of the invention. This poly-robot 100f comprises three cooperative mobile robots 110a, 110b, 110c as described above, thereby forming a tri-robot.

Since the three cooperative mobile robots 110a, 110b, 110c, 110d form three points of contact with the ground, the respective stabilization means 120a, 120b, 120c, thereof are folded away along each slim structure. Folding can be performed manually or by a motor arranged in the slim structure or in the stabilization means acting on the pivot linkage described above. The stabilization means can be unfolded to once again form a point of support on the ground if one cooperative mobile robot is detached or in some situations for example in order to increase the stability during load stacking.

The poly-robot 100d comprises connection means 130a, 130b, 131 making it possible to mechanically link the cooperative mobile robots together: the cross-bars 130a and 130b in the form of right-angled beams connect, on the one hand, the cooperative mobile robot 110a to the cooperative mobile robot 110b and the cooperative mobile robot 110b to the cooperative mobile robot 110c.

Another connection means is formed by a lateral stacking device 131 as described above.

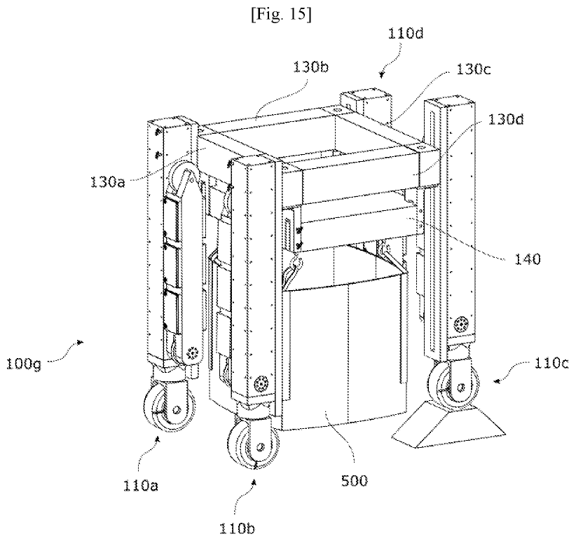

FIG. 15 is a schematic perspective view of a poly-robot 100g in accordance with a seventh embodiment of the invention. This poly-robot 100g comprises four cooperative mobile robots 110a, 110b, 110c, 110d as described above, thereby forming a quadri-robot. With respect to the fifth embodiment described above, the lateral stacking device is replaced by a device 140 for carrying flexible containers 500, of the flexible intermediate bulk container-type (FIBC) or “big bag”. The poly-robot also comprises four cross-bars 130a, 130b, 130c, 130d configured to connect the lifting means of the cooperative mobile robots.

This embodiment makes it possible to carry loads in a stable manner between the cooperative mobile robots.

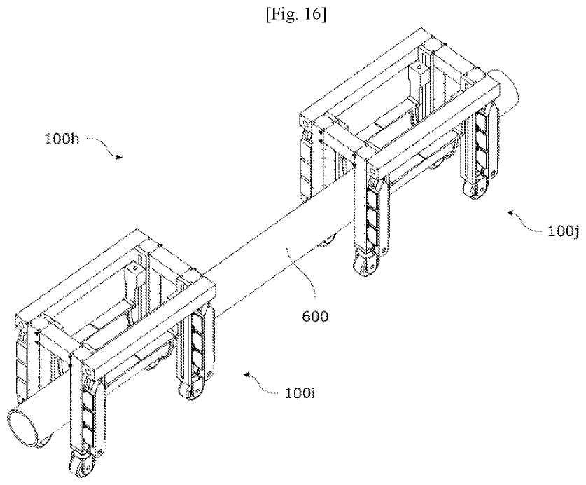

FIG. 16 is a schematic perspective view of a group 100h of poly-robots in accordance with an eighth embodiment of the invention, formed of two poly-robots 100i and 1100j each formed of four cooperative mobile robots, thereby forming an octo-robot, configured to move a long load such as a beam 600 or a long pipe owing to the use of tabs attached to the lifting means. By adding a third poly-robot to the octo-robot, it is possible to obtain a dodeca-robot for carrying a longer or heavier load.

Other connection means between the mobile robots are possible, for example a kinematic chain of the following types:
nesting-ball joint-slide-ball joint-nesting;
nesting-ball joint-pivot-ball joint-nesting;
nesting-n pivots-nesting with n being an integer greater than or equal to 0:
   if n=0, the connection means is equivalent to a rigid plate or cross-bar as described above, the shape of which can vary;
   if n=6, this is a kinematic chain with six degrees of connectivity similar to that of handling arms and allowing any position or orientation of one mobile robot with respect to another;
   if n>6, the kinematic chain becomes redundant and makes it further possible to bypass the load or become fixed on a hidden anchoring point.
etc.

The invention is not limited to the embodiments described. In particular, the number and configuration of the mobile robots in a poly-robot can vary, the number and location of the stabilization means of each cooperative mobile robot individually or in a poly-robot can vary, the number and position of the batteries can vary, etc.

Furthermore, the embodiments can be combined if the structure thereof so allows, for example the different lifting means (tray, single fork, double fork, lateral stacking device, etc.) can be adapted to different types of mono-robot and poly-robot, the handling arm can be at different positions on a mono-robot (on the structure, on the lifting means, etc.) or on one or more of the cooperative mobile robots of a poly-robot.

1. A cooperative mobile robot, comprising:
a slim structure in the form of a column in a main longitudinal direction which is oriented substantially upwards when the robot is in the operating position,
at least one locomotion means which is arranged at a lower end of said slim structure and is configured to provide at least a first point of contact with the ground when the robot is in the operating position,
at least one stabilization means which is connected to the slim structure and is configured to provide at least a second point of contact with the ground when the robot is in the operating position, and
at least one attachment means which is configured to receive at least one means of structural connection with another cooperative mobile robot.

2. The cooperative mobile robot as claimed in claim 1, further comprising at least one vertical lifting means, configured to allow raising of a load in an axis substantially parallel to the main longitudinal direction.

3. The cooperative mobile robot as claimed in claim 2, wherein the slim structure comprises a guide rail extending in a direction substantially in parallel with the main longitudinal direction of the slim structure, said guide rail being configured to receive at least one vertical lifting means.

4. The cooperative mobile robot as claimed in claim 1, wherein the locomotion means are formed by a wheel and means for steering the wheel about an axis which substantially coincides with the main longitudinal direction of the slim structure.

5. The cooperative mobile robot as claimed in claim 1, further comprising at least one handling arm.

6. The cooperative mobile robot as claimed in claim 1, further comprising means for measuring a force applied by a load and transmitted to the ground via the points of contact with the ground, when the robot is in the operating position.

7. The cooperative mobile robot as claimed in claim 6, further comprising a stability management device, configured to adjust the position of each stabilization means based on at least said measured force.

8. The cooperative mobile robot as claimed in claim 1, wherein at least one stabilization means comprises a load-bearing box and a wheel arranged at a first end of the box and forming the second point of contact with the ground, said box being fixed to the slim structure by a pivot linkage at a second end of the arm.

9. The cooperative mobile robot as claimed in claims1, wherein at least one stabilization means comprises at least one battery for supplying the cooperative mobile robot with power.

10. A group comprising:
at least two cooperative mobile robots and at least one connection means configured for mechanically linking the cooperative mobile robots of the group, the robots comprising:
a slim structure in the form of a column in a main longitudinal direction which is oriented substantially upwards when the robot is in the operating position,
at least one locomotion means which is arranged at a lower end of said slim structure and is configured to provide at least a first point of contact with the ground when the robot is in the operating position,
at least one stabilization means which is connected to the slim structure and is configured to provide at least a second point of contact with the ground when the robot is in the operating position, and
at least one attachment means which is configured to receive at least one means of structural connection with another cooperative mobile robot.

11. The group of cooperative mobile robots as claimed in claim 10, wherein at least one connection means is connected to lifting means of at least two cooperative mobile robots.

12. The group of cooperative mobile robots as claimed in claim 10, further comprising means for overcoming obstacles, comprising:
means for elevating at least one locomotion means by a lifting means of a cooperative mobile robot,
means for maintaining the stability margin by controlling the elevating means and said locomotion means from information representing internal forces gathered by the force-measuring means of one or more cooperative mobile robots.

13. The group of cooperative mobile robots as claimed claim 10, further comprising at least three cooperative mobile robots, and in that at least one connection means forms a lateral pallet stacking device, configured to be connected to each cooperative mobile robot.

14. The group of cooperative mobile robots as claimed in claim 10, further comprising two cooperative mobile robots each comprising lifting means formed of a single fork and comprising at least one stabilization means.

15. The group of cooperative mobile robots as claimed in claim 10, wherein each connection means comprises at least one mechanical and/or electrical and/or hydraulic transmission means.
